(19) United States
(12) Patent Application Publication
(10) Pub. No.: US 2004/0160504 A1
(43) Pub. Date: Aug. 19, 2004

(54) Ink jet-use recording sheet

(76) Inventors: Yoshihiko Tomita, Chiba (JP); Masaya Kusumoto, Chiba (JP); Tadashi Ishida, Chiba (JP)

Correspondence Address: BURNS DOANE SWECKER & MATHIS L L P, POST OFFICE BOX 1404, ALEXANDRIA, VA, 22313-1404, US

(21) Appl. No.: 10/480,933

(22) PCT Filed: Jul. 11, 2002
(86) PCT No.: PCT/JP02/07059

(30) Foreign Application Priority Data
Jul. 11, 2001 (JP) 2001-210894

(51) Int. Cl. B41J 2/01; B41M 5/00

(52) U.S. Cl. 347/105

(57) ABSTRACT

An ink jet recording sheet comprising a sheet support and, superimposed thereon, at least one layer containing organic particles,

the organic particles having a property of swelling in water so as to have a particle diameter which is 5.0 times that exhibited in the dry state or greater.

The thus provided ink jet recording sheet is excellent in ink absorptivity and ozone resistance.

### TECHNICAL FIELD

The present invention relates to an ink jet recording sheet applied to a printer or plotter wherein the ink jet recording system is utilized.

### BACKGROUND ART

The recording system known as the ink jet recording system can provide images which are by no means inferior to those provided by printing and photography, so that the application thereof is widening in the field of full color image recording. In the recording of full color images, it is intended to attain enhancement of resolution and expansion of color reproduction range by increasing the amount of ink jetted. Therefore, an increase of ink absorption capacity in conformity with the amount of ink jetted is an important technical task for recording sheets, and an ink absorptivity is an important property demanded on recording sheets.

Providing a coating layer of high void ratio is desired for ensuring an ink absorption. A mixture of inorganic particles and a small amount of binder capable of binding the inorganic particles together is known as a coating composition for forming the above coating layer. This coating composition is one wherein the amount of binder is so small that voids are formed between inorganic particles to thereby ensure an ink absorptivity.

Ink absorptivity has been enhanced by forming the above coating layer, whereby it has become feasible to obtain images of high quality. However, this recording system still poses a problem with respect to the storability of recorded images, as compared with photography.

The problem of storability is attributed to fading of recorded images by light or an oxidative gas, such as SOx, NOx, oxygen or ozone (generally, the storability to light is referred to as light fastness, and the storability to an oxidative gas is referred to as gas resistance; in particular, ozone gas is generally used in the evaluation of gas resistance, so that this property is generally referred to as ozone resistance).

Now widely used recording sheets involve such a problem that the void ratio of coating layer thereof has been increased in order to enhance an ink absorptivity, so that the probability of contact with an oxidative gas is increased to result in a deterioration of ozone resistance.

On the other hand, silica or alumina has generally been used as the inorganic particles. These inorganic particles pose such a problem that the surface activity thereof is so high that the light fastness and ozone resistance of recorded images are poor.

When it is intended to impart gloss to the surface of recording paper, gloss has been imparted by forming a coating layer with the use of finer inorganic particles selected so as to smooth the surface. However, the finer the inorganic particles, the more sharply will the surface area thereof increase. Thus, the use of finer inorganic particles poses such a problem that the surface activity is further increased to result in further deterioration of the light fastness and ozone resistance of recorded images.

As apparent from the above, it would be difficult to obtain an ink jet recording sheet which is excellent in both ink absorptivity and ozone resistance by the employment of measures based on the conventional technique of using inorganic particles.

Therefore, various improvement technologies have been proposed. Examples of the current improvement technologies are as follows.

For example, Japanese Patent Laid-open Publication No. 7(1995)-266689 discloses that a recording medium having excellent ozone resistance can be obtained by the use of a polyallylamine. The polyallylamine is a water-soluble polymer.

Further, Japanese Patent Laid-open Publication No. 8(1996)-164664 discloses a recording sheet wherein an ink receiving layer comprising inorganic particles having cycloamylose fixed thereto and a binder is formed. An ink pigment is enclosed by cycloamylose in this recording sheet, so that the ozone resistance of the recording sheet is enhanced.

Still further, Japanese Patent Laid-open Publication No. 9(1997)-254526 discloses an ink jet recording sheet wherein an ink receiving layer comprising an inorganic sol and a polysiloxane polymer as a binder resin is formed. In this recording sheet, the polysiloxane polymer which is an inorganic polymer is highly resistant to deterioration by ozone, ultraviolet radiation or the like, so that the image storability of the recording sheet is enhanced.

As apparent from the above, recording sheets having the ozone resistance enhanced by the use of specified organic polymers or inorganic polymers have hitherto been proposed, which are however not always satisfactory.

In these circumstances, the inventors have made extensive and intensive studies. As a result, it has been found that an ink jet recording sheet comprising a sheet support and, superimposed thereon, at least one layer containing organic particles, which organic particles exhibit such a swelling ratio that the particle diameter in water is 5.0 times that exhibited in the dry state or greater, or are soluble in water, is surprisingly not only excellent in ink absorptivity but also highly excellent in ozone resistance. The present invention has been completed on the basis of this finding.

The applicant, in Japanese Patent Laid-open Publication No. 10(1998)-305654, has proposed an ink jet recording sheet wherein an ink receiving layer containing dry polymer particles capable of being swollen in water into a hydrogel, the dry polymer particles having a particle diameter of 0.05 to 3 μm in the dry state, is formed. In this proposal, it is intended to enhance an ink absorptivity by the employment of particles capable of absorbing water.

The ink absorptivity of the recording sheet per se is enhanced by the use of particles capable of absorbing water. However, the swelling ratio of the organic particles described in the above Japanese Patent Laid-open Publication No. 10(1998)-305654 is so low that the effect exerted by the organic particles is unsatisfactory. Further, the ozone resistance of the recording sheet is not necessarily excellent. Thus, it is apparent that only the capability of absorbing inks has been unable to satisfactorily solve the problem of deterioration of ozone resistance, which is an important property.

### OBJECT OF THE INVENTION

Accordingly, it is an object of the present invention to provide an ink jet recording sheet which is excellent in both ozone resistance and ink absorptivity in order to solve the above problems.

### DISCLOSURE OF THE INVENTION

Therefore, the present invention is characterized by the following features [1] to [9].

[1] The ink jet recording sheet of the present invention comprises a sheet support and, superimposed thereon, at least one layer containing organic particles,

the organic particles having a property of swelling in water so as to have a particle diameter which is 5.0 times that exhibited in the dry state or greater, or being soluble in water.

[2] It is preferred that the particle diameter of the organic particles in the dry state be in the range of 50 to 2000 nm.

[3] The organic particles are preferably organic particles having at least one hydrophilic group selected from among a carboxylic acid group and an amino group.

[4] Preferably, the organic particles according to the above feature [3] are organic particles obtained by copolymerizing:

(A) at least one monomer selected from among a carboxylic acid having a polymerizable double bond, an aminated (meth)acrylate monomer and an aminated (meth)acrylamide monomer,

(B) a monomer having one polymerizable double bond other than the monomer (A), and

(C) a monomer having two polymerizable double bonds other than the monomer (A).

[5] With respect to the organic particles according to the above feature [4], it is preferred that the monomer (A) be used in an amount of 10 to 50% by weight, the monomer (B) in an amount of 50 to 90% by weight, and the monomer (C) in an amount of 0 to 6% by weight, based on the total weight of monomers (A) to (C).

[6] It is preferred that at least one member selected from among methyl methacrylate, acrylamide and methacrylamide be contained as the monomer (B) having one polymerizable double bond other than the monomer (A) in an amount of 40 to 100% by weight based on the total weight of the monomer (B) having one polymerizable double bond other than the monomer (A).

[7] These organic particles preferably have a glass transition temperature of 40° C. or higher.

[8] These organic particles preferably have a weight average molecular weight of 5000 to 200,000.

[9] It is preferred that the layer containing these organic particles further contain inorganic particles and/or a polymer having a binder function.

### BEST MODE FOR CARRYING OUT THE INVENTION

The ink jet recording sheet of the present invention comprises a sheet support and, superimposed thereon, at least one layer containing organic particles, the organic particles exhibiting such a swelling ratio that the particle diameter in water is 5.0 times that exhibited in the dry state or greater, or being soluble in water. The ink jet recording sheet realizes both excellent ink absorptivity and ozone resistance.

The organic particles for use in the recording sheet of the present invention retains particulate form in the dry state and hence can form interparticulate voids. Therefore, the organic particles are the same void forming component as provided by inorganic particles, such as those of silica and alumina, employed in the prior art. Because of this characteristic, the organic particles realize excellent ink absorptivity. Further, after printing, the particles are swollen or dissolved by the ink, so that the voids would be eliminated. Consequently, the contact between external air and dye would be inhibited, so that excellent ozone resistance can be realized.

The constitution of the present invention will be described in detail below.

[Variety of Sheet Support]

In the present invention, as the support, use can be made of supports conventionally employed in ink jet recording sheets, for example, a paper support such as plain paper, art paper, coated paper, cast coated paper, resin coated paper, resin impregnated paper, noncoated paper or coated paper, a paper support having its both sides or one side coated with polyethylene and/or a polyolefin such as polyethylene having titanium or other white pigment milled therein, a plastic support, a nonwoven fabric, a cloth, a woven fabric, a metal film, a metal plate, and a composite support consisting of a laminate of these.

As the plastic support, there can preferably be used, for example, a sheet or film of plastic such as polyethylene, polypropylene, polystyrene, polyethylene terephthalate, polyethylene naphthalate, triacetylcellulose, polyvinyl chloride, polyvinylidene chloride, polyimide, polycarbonate, cellophane or polynylon. Among these plastic supports, transparent, translucent, or opaque ones can appropriately be selected according to intended use.

It is also preferred to use a white plastic film as the support. As the white plastic support, use can be made of a support constituted of a plastic compounded with a small amount of white pigment such as barium sulfate, titanium oxide or zinc oxide, a foamed plastic support provided with translucency by forming a multiplicity of minute voids, or a support furnished with a layer containing a white pigment (e.g., titanium oxide or barium sulfate).

In the present invention, although the configuration of the support is not limited, not only customarily employed films, sheets and plates but also cylindrical form such as that of a drink can, disc form as that of CD or CD-R and other complex forms can be used as the support.

[Organic Particles]

The organic particles for use in the present invention exhibit such a swelling ratio that the particle diameter in water is 5.0 times that exhibited in the dry state or greater, or are soluble in water. From the viewpoint of enhancing the ozone resistance of recording sheet, it is preferred that the organic particles exhibit such a swelling ratio that the particle diameter in water is 6.0 times that exhibited in the dry state or greater, or be soluble in water. Still preferably, the organic particles exhibit such a swelling ratio that the particle diameter in water is 7.0 times that exhibited in the dry state or greater, or are soluble in water. The most suitable organic particles are those dissolved in water.

In the present invention, the measuring of particle diameter in the dry state can be performed by observation through an electron microscope, while the measuring of particle diameter with respect to particles dispersed in water can be performed by the light scattering method. For example, in the light scattering method, the measuring can be performed by the use of laser particle diameter analyzing system LPA-3000/3100 (Otsuka Electronics Co., Ltd.), laser diffraction particle size measuring instrument SALD-2000A (Shimadzu Corporation), or the like.

In the evaluation of the swollen particle diameter or solubility of organic particles in water, use is made of water adjusted to pH 8. The temperature of water at evaluation is 25° C., and the immersion time of organic particles in water is 12 hr.

In the present invention, the diameter of organic particles in the dry state is in the range of 10 nm to 2000 nm, preferably 10 nm to 700 nm, and still preferably 10 nm to 500 nm. Further, in the use in gloss paper or semigloss paper wherein smoothness is required for the recording sheet surface, it is preferred that the diameter of organic particles be in the range of 10 nm to 200 nm. When the diameter of organic particles is less than the lower limit of the above ranges, there would occur such a problem that the interparticulate voids are insufficient to thereby lead to poor ink absorptivity and to deterioration of dryability and image quality. On the other hand, when the diameter of organic particles is increased over the above ranges, the number of organic particles per fixed weight is reduced to thereby cause the total surface area of all organic particles to decrease, so that the area of contact with the ink would be reduced so as to be unable to attain satisfactory particle swell or dissolution with the result that any satisfactory ef fect in ozone resistance cannot be exerted. Further, when the diameter of organic particles is increased, the transparency of the layer containing the organic particles would lower, so that the viewability of dye in or under the layer may be decreased to result in deterioration of color strength.

The organic particles of the present invention exhibit such a swelling ratio that the particle diameter in water is 5.0 times that exhibited in the dry state or greater, or are soluble in water. From the viewpoint of imparting this function, it is preferred that the organic particles be those having at least one group selected from among a carboxylic acid group and an amino group.

Still preferably, the organic particles are those obtained by copolymerizing:

(A) a monomer selected from among a carboxylic acid having a polymerizable double bond, an aminated (meth)acrylate monomer and an aminated (meth)acrylamide monomer,

(B) a monomer having one polymerizable double bond other than the monomer (A), and

(C) a monomer having two polymerizable double bonds other than the monomer (A).

The constituent ratio of monomers (A), (B) and (C) is a factor which is important from the viewpoint of attaining not only the object of imparting water swellability to organic particles so as to exhibit excellent ozone resistance but also the object of forming interparticulate voids so as to exhibit excellent ink absorptivity. Thus, it is preferred that the monomer (A) be used in an amount of 10 to 50% by weight, the monomer (B) in an amount of 50 to 90% by weight, and the monomer (C) in an amount of 0 to 6% by weight, based on the total weight of monomers (A) to (C). Still preferably, the monomer (A) is used in an amount of 15 to 45% by weight, the monomer (B) in an amount of 55 to 85% by weight, and the monomer (C) in an amount of 0 to 6% by weight, based on the total weight of monomers (A) to (C) It is especially preferred that the monomer (A) be used in an amount of 15 to 40% by weight, the monomer (B) in an amount of 60 to 85% by weight, and the monomer (C) in an amount of 0 to 6% by weight, based on the total weight of monomers (A) to (C).

When the amount of monomer (A) exceeds the above upper limit, it may occur that the formation of interparticulate voids is reduced to result in a deterioration of ink absorptivity. On the other hand, when the amount of monomer (A) is less than the above lower limit, it may occur that the swelling or dissolution of particles by inks becomes unsatisfactory to result in a deterioration of ozone resistance.

The monomer (C) functions as a crosslinking agent for the polymer contained in the particles, so that swellable organic particles can be obtained when the monomer (C) is contained. Even within the above range, the less the amount of monomer (C), the larger the swelling ratio of organic particles. In particular, when the amount of monomer (C) is swelling 0% (not contained) or substantially close to 0%, the organic particles would become dissolved in water.

The components (A) to (C) for constituting the organic particles will be described in greater detail below.

As the carboxylic acid monomer (A), there can be mentioned, for example, acrylic acid, methacrylic acid, itaconic acid, maleic acid, fumaric acid, maleic anhydride or the like.

As the aminated (meth)acrylate monomer, there can be mentioned, for example, an aminoalkyl acrylate or aminoalkyl methacrylate such as N,N-dimethylaminoethyl acrylate, N,N-dimethylaminoethyl methacrylate, N,N-dimethylaminopropyl acrylate, N,N-dimethylaminopropyl methacrylate, N,N-t-butylaminoethyl acrylate, N,N-t-butylaminoethyl methacrylate, N,N-monomethylaminoethyl acrylate or N,N-monomethylaminoethyl methacrylate, or a quaternary salt by a methyl halide, an ethyl halide, a benzyl halide or the like.

As the aminated (meth)acrylamide monomer, there can be mentioned,. for example, an N-aminoalkylacrylamide or N-aminoalkylmethacrylamide such as N,N-dimethylaminopropylacrylamide, N,N-dimethylaminopropylmethacrylamide, N,N-dimethylaminoethylacrylamide or N,N-dimethylaminoethylmethacrylamide, or a monomer of the above N-aminoalkylacrylamide or N-aminoalkylmethacrylamide converted to a quaternary salt by a halogenated hydrocarbon, such as a methyl halide, an ethyl halide or a benzyl halide, wherein the halogen is, for example, chlorine, bromine or iodine.

One, or two or more members can be selected from among these for use as the component (A).

Among these, from the viewpoint of enhancing the ozone resistance of recording sheet, it is especially preferred to use methacrylic acid or acrylic acid as the carboxylic acid monomer; to use a quaternary salt of N,N-dimethylaminopropyl methacrylate, N,N-dimethylaminopropyl acrylate, N,N-dimethylaminoethyl methacrylate or N,N-dimethylaminoethyl acrylate as the aminated (meth)acrylate monomer; and to use a quaternary chloride of N,N-dimethylaminopropyl(meth)acrylamide or N,N-dimethylaminoethyl(meth)acrylamide as the aminated (meth)acrylamide monomer.

As the monomer (B) having one polymerizable double bond other than the-monomer (A), there can be mentioned, for example, the following compounds:

acrylamides such as acrylamide, methacrylamide, methylolmethacrylamide, diacetonacrylamide and maleinamide; acrylic acid esters such as methyl acrylate, ethyl acrylate, isopropyl acrylate, n-butyl acrylate, isobutyl acrylate, t-butyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate and other alkyl acrylates each having 1 to 12 carbon atoms; methacrylic acid esters such as methyl methacrylate, ethyl methacrylate, isopropyl methacrylate, n-butyl methacrylate, isobutyl methacrylate, t-butyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate and other alkyl methacrylates each having 1 to 12 carbon atoms; hydroxylated acrylates or methacrylates such as 2-hydroxyethyl acrylate, 2-hydroxypropyl acrylate, 3-hydroxypropyl acrylate, 4-hydroxybutyl acrylate, 2-hydroxyethyl methacrylate, 2-hydroxypropyl methacrylate, 3-hydroxypropyl methacrylate and 4-hydroxybutyl methacrylate; aromatic vinyls such as styrene, 2-methylstyrene, t-butylstyrene, chlorostyrene, vinylanisole and vinylnaphthalene; vinylidene halides such as vinylidene chloride and vinylidene fluoride; vinyl esters such as vinyl acetate and vinyl propionate; vinyl chloride, vinyl ether, vinyl ketone, vinylamide, ethylene, propylene, 2-methoxyethyl acrylate, 2-ethoxyethyl acrylate, glycidyl acrylate, glycidyl methacrylate, allyl glycidyl ether, acrylonitrile, methacrylonitrile, allyl methacrylate, dicyclopentenyl acrylate, dicyclopentenyloxyethyl acrylate, isopropenyl-α,α-dimethylbenzyl isocyanate, allylmercaptan and the like; and 2-(2′-hydroxy-5′-methacryloyloxyethylphenyl)-2H-benzotriazole, 2-(2′-hydroxy-5′-methacryloyloxyethylphenyl)benzotriazole, 2-hydroxy-4-(2-methacryloyloxy)eethoxybenzophenone and 2-(2′-hydroxy-5′-methacryloyloxyphenyl)-5-chlorobenzotriazole.

One, or two or more members can be selected from among these for use as the component (B). It is preferred to use any of methyl methacrylate, acrylamide and methacrylamide, or a mixture thereof as the component (B). Containing at least methyl methacrylate, acrylamide or methacrylamide as the component (B) is still preferred from the viewpoint of enhancing the ozone resistance of recording sheet. The total content of monomers selected from among methyl methacrylate, acrylamide and methacrylamide based on the total weight of components (B) is preferably in the range of 40 to 100% by weight, still preferably 50 to 100% by weight, and further still preferably 60 to 100% by weight. Containing methyl methacrylate as the component (B) is the most suitable. In that event, the content of methyl methacrylate based on the total weight of components (B) is preferably in the range of 40 to 100% by weight, still preferably 50 to 100% by weight, and further still preferably 60 to 100% by weight.

As the monomer (C) having two polymerizable double bonds other than the monomer (A), there can be mentioned, for example, the following compounds:

methylenebisacrylamide, bisacrylamidoacetic acid, divinylbenzene, isoprene, butadiene, chloroprene, vinylpyrrolidone, ethylene glycol dimethacrylate, diethylene glycol dimethacrylate, triethylene glycol dimethacrylate, polyethylene glycol dimethacrylate, polypropylene glycol dimethacrylate, neopentyl glycol dimethacrylate, 1,3-butylene glycol dimethacrylate, 1,6-hexanediol dimethacrylate, neopentyl glycol dimethacrylate, polyethylene glycol diacrylate, 1,6-hexanediol diacrylate, neopentyl glycol diacrylate, tripropylene glycol diacrylate, polypropylene glycol diacrylate, trimethylolpropane trimethacrylate, trimethylolpropane triacrylate, tetramethylolmethane triacrylate and tetramethylolmethane tetraacrylate.

Glass transition temperature of organic particles (Tg)

The glass transition temperature of organic particles according to the present invention is preferably 40° C. or higher, still preferably in the range of 60 to 250° C., and further still preferably 60 to 200° C. When the glass transition temperature is below 40° C., the deformation of organic particles would be increased to thereby reduce minute interparticulate voids with the result that the ink absorptivity of recording sheet may be deteriorated. Further, when a coating layer containing organic particles of low glass transition temperature is dried, the drying temperature must be low for forming interparticulate voids, so that the production efficiency may be low.

The glass transition temperature referred to herein can be determined from DSC curve in accordance with Japanese Industrial Standard (JIS) K 7121.

Molecular weight of organic particles The weight average molecular weight of organic particles according to the present invention is preferably in the range of 5000 to 200,000, still preferably 5000 to 100,000. When the weight average molecular weight is less than 5000, the deformation of organic particles would be likely to occur to thereby reduce interparticulate voids with the result that the ink absorptivity of recording sheet may be poor. On the other hand, when the weight average molecular weight exceeds 100,000, the water swellability or solubility of organic particles would be decreased with the result that the ozone resistance of recording sheet may be poor.

Process for producing organic particles The organic particles for use in the present invention can be produced by the known emulsion polymerization process or precipitation polymerization process. For example, in the emulsion polymerization process, a method wherein, using water as a solvent, various monomers are charged at one time and polymerized in the presence of a dispersant and an initiator, or a method wherein monomers are continuously fed and polymerized can be employed. Further, the precipitation polymerization process wherein polymerization is performed in an organic solvent and a polymer is precipitated to thereby obtain particles can be employed. In this precipitation polymerization process as well, a dispersant can be used in order to stably form particles. The organic solvent for use in the precipitation polymerization process is of such a type that the monomers for use in the polymerization are dissolved therein but the produced polymer is not dissolved therein. For example, the organic solvent can be any of isopropyl alcohol, methyl ethyl ketone, ethyl acetate, methanol, ethanol, n-butanol and the like. At least one member can appropriately be selected from these and used.

In both the above emulsion polymerization and precipitation polymerization, the polymerization temperature may generally be in the range of 30 to 90° C. As a result of reaction, a dispersion of organic particles can be obtained.

When the organic particles are those obtained by copolymerizing one, or two or more monomers (A) selected from among a carboxylic acid having a polymerizable double bond, an aminated (meth)acrylate monomer and an aminated (meth)acrylamide monomer with another copolymerizable monomer (B), the emulsion polymerization process is suitable in the event that methyl methacrylate is used as the monomer (B) while the precipitation polymerization process is suitable in the event that acrylamide or methacrylamide is used as the monomer (B).

When acrylamide or methacrylamide is used as the monomer (B), it is preferred to use, in combination therewith, a monomer having at least two polymerizable unsaturated bonds in its molecule. (C), such as methylenebisacrylamide or bisacrylamidoacetic acid.

Examples of preferably used dispersants include an anionic surfactant, a cationic surfactant, a nonionic surfactant and a water soluble polymer. One, or two or more members can be selected from among these.

As the anionic surfactant, there can be mentioned, for example, sodium dodecylbenzenesulfonate, sodium lauryl sulfate, sodium alkyl diphenyl ether disulfonate, sodium alkylnaphthalenesulfonate, sodium dialkylsulfosuccinate, sodium stearate, potassium oleate, sodium dioctylsulfosuccinate, sodium polyoxyethylene alkyl ether sulfate, sodium polyoxyethylene alkyl ether sulfate, sodium polyoxyethylene alkylphenyl ether sulfate, sodium oleate, sodium tert-octylphenoxyethoxypolyethoxyethyl sulfate or the like.

As the nonionic surfactant, there can be mentioned, for example, polyoxyethylene lauryl ether, polyoxyethylene octylphenyl ether, polyoxyethylene oleylphenyl ether, polyoxyethylene nonylphenyl ether, oxyethylene/oxypropylene block copolymer, tert-octylphenoxyethylpolyethoxyethanol, nonylphenoxyethylpolyethoxyethanol or the like.

As the cationic surfactant, there can be mentioned, for example, lauryltrimethylammonium chloride, stearyltrimethylammonium chloride, cetyltrimethylammonium chloride, distearyldimethylammonium chloride, alkylbenzyldimethylammonium chloride, laurylbetaine, stearylbetaine, lauryldimethylamine oxide, laurylcarboxymethylhydroxyethylimidazolinium betaine, coconut amine acetate, stearylamine acetate, alkylamine guanidine polyoxyethanol, alkylpicolinium chloride or the like.

As the water soluble polymer, there can be mentioned, for example, polyvinyl alcohol, polyvinylpyrrolidone, modified polyvinyl alcohol or the like.

The amount of dispersant used, although not particularly limited, is generally in the range of 0.02 to 10% by weight, preferably 0.02 to 5% by weight, and most suitably 0.02 to 3% by weight based on the total weight of monomers copolymerized.

The initiator for use in the polymerization can be any of common radical initiators, for example, hydrogen peroxide; persulfates such as ammonium persulfate and potassium persulfate; organic peroxides such as cumene hydroperoxide, t-butyl hydroperoxide, benzoyl peroxide, t-butyl peroxy-2-ethylhexanoate, t-butyl peroxybenzoate and lauroyl peroxide; azo compounds such as azobisisobutyronitrile, 2,2′-azobis(2-amidinopropane) dihydrochloride, 2,2′-azobis[2-(N-phenylamidino)propane]dihydrochloride, 2,2′-azobis{2-[N-(4-chlorophenyl)amidino]propane}dihydrochloride, 2,2′-azobis{2-[N-(4-hydroxyphenyl)amidino]propane}dihydrochloride, 2,2′-azobis[2-(N-benzylamidino)propane]dihydrochloride, 2,2′-azobis[2-(N-allylamidino)propane]dihydrochloride, 2,2′-azobis{2-[N-(2-hydroxyethyl)amidino]propane}dihydrochloride, 2,2′-azobis{2-methyl-N-[1,1-bis(hydroxymethyl)-2-hydroxyethyl]propionamido}, 2,2′-azobis{2-methyl-N-[1,1-bis(hydroxymethyl)ethyl]propionamido}, 2,2′-azobis[2-methyl-N-(2-hydroxyethyl)propionamido] and 2,2′-azobis(isobutylamido) dihydrate; and redox initiators consisting of a mixture of any of these, a metal ion, such as iron ion, and a reducing agent, such as sodium sulfoxylate, formaldehyde, sodium pyrosulfite, sodium hydrogen sulfite, L-ascorbic acid or rongalite. One, or two or more members can be selected from among these initiators.

The amount of initiator used may generally be in the range of 0.01 to 5% by weight based on the total weight of monomers copolymerized.

Further, according to necessity, a mercaptan such as t-dodecylmercaptan or n-dodecylmercaptan, an allyl compound such as allylsulfonic acid, methallylsulfonic acid or a sodium salt thereof, or the like can be used as a molecular weight modifier. The molecular weight of organic particles can be modified by the use of these chain transfer agents. The amount and type thereof can appropriately be selected so as to realize excellent water swellability or solubility.

In the present invention, the organic particles are employed, so that a coating layer wherein the same ihterparticulate voids as those of inorganic particles are retained until printing can be formed. Further, after printing, the organic particles are swollen or dissolved by an ink so as to result in elimination of the interparticulate voids. Consequently, the penetration of gas would be inhibited, thereby attaining enhanced ozone resistance. Still further, in the use of inorganic particles, a binder capable of binding particles together for retaining a surface strength is inevitably needed. The binder would fill up the interparticulate voids so as to reduce the void ratio, thereby deteriorating the ink absorptivity of recording sheet. By contrast, the organic particles of the present invention are different from the inorganic particles and realize such a feature, not exhibited by the inorganic particles, that only surface portions of particles are slightly fused together so as to be able to realize the formation of interparticulate voids and the improvement of surface strength with the result that excellent ink absorptivity can be ensured in the use of organic particles only, namely, even if the content of organic particles in a layer containing organic particles is 100% by weight. Yet still further, the present invention realizes such an excellent feature that when it is intended to obtain a recording sheet furnished with a gloss surface, the organic particles which are present in surface portions thereof can partly be deformed so as to enhance the smoothness of the surface.

[Layer Containing Organic Particles]

In the present invention, at least one layer containing the above water swellable or soluble organic particles is provided on a surface of the above support.

The content of organic particles in the layer containing organic particles is preferably in the range of 5 to 100% by weight, still preferably 20 to 100% by weight, and further still preferably 40 to 100% by weight. When the organic particle content is less than the above lower limit, the effect of the organic particles may be unsatisfactory to result in failure to satisfactorily exert an effect of enhancing the ozone resistance of recording sheet.

This layer containing organic particles can be loaded with not only the above organic particles but also inorganic particles and other organic particles which do not exhibit water swellability or solubility. Examples of the inorganic particles include those of precipitated calcium carbonate, heavy calcium carbonate, magnesium carbonate, kaolin, clay, talc, calcium sulfate, barium sulfate, titanium dioxide, zinc oxide, zinc hydroxide, zinc sulfide, zinc carbonate, hydrotalcite, aluminum silicate, diatom earth, calcium silicate, magnesium silicate, synthetic amorphous silica, colloidal silica, alumina, colloidal alumina, pseudo-boehmite, aluminum hydroxide, lithopone, zeolite, magnesium hydroxide and the like. Among these, silica and alumina are preferred from the viewpoint of attaining a high void ratio to thereby enhance the ink absorptivity of recording sheet. LFine particles of silica or alumina having a primary particle diameter of 100 nm or less are still preferred.

Examples of the other organic particles include organic particles of a polymer obtained by copolymerizing 70 to 100% by weight of at least one member selected from among monomers including an aromatic vinyl such as styrene, a methacrylic acid ester not containing any hydrophilic group such as a carboxylic acid group or an amino group and an a-olefin such as ethylene and 0 to 30% by weight of another copolymerizable monomer. Among these other organic particles, fine particles of 100 nm or less diameter are preferred from the viewpoint of attaining a high void ratio to thereby enhance the ink absorptivity of recording sheet.

When it is intended to load the layer containing the organic particles of the present invention with these inorganic particles and other organic particles, the appropriate total amount of inorganic particles and other organic particles is 80 parts by weight or less, preferably 70 parts by weight or less, and still preferably 60 parts by weight or less, per 100 parts by weight of the layer.

From the viewpoint of ensuring excellent ozone resistance, it is preferred that the total amount of inorganic particles and other organic particles do not exceed the above upper limit. When only inorganic particles are used and the amount thereof exceeds the above upper limit, the ozone resistance of recording sheet may be deteriorated by the activity of inorganic particles.

In order to enhance the surface strength and gloss, the layer containing the organic particles of the present invention may be loaded with a polymer having binder functions. As the polymer having binder functions, there can be mentioned, for example, a water soluble polymer such as polyvinyl alcohol, modified polyvinyl alcohol, polyvinylpyrrolidone, starch, gelatin or casein.

When it is intended to use the polymer having binder functions, the use amount thereof is preferably in the range of 0 to 40 parts by weight, still preferably 0 to 30 parts by weight, and further still preferably 0 to 20 parts by weight, per 100 parts by weight of organic particles (total amount when inorganic particles and/or other organic particles are contained). When the amount of polymer having binder functions is in excess, the binder polymer may fill up the interparticulate voids so as to deteriorate the ink absorptivity of recording sheet.

[Other]

In order to enhance the water resistance, the ink jet recording sheet of the present invention may be further provided with at least one layer containing a cationic polymer. Anionic dye of an ink is fixed by virtue of the formation of the layer containing a cationic polymer, so that after printing, the move of dye upon contact with water is restricted to thereby enable obtaining a recording sheet of excellent water resistance.

The layer to be loaded with the cationic polymer is not limited as long as the cationic polymer is contained in an layer for absorbing an ink. For example, the cationic polymer may be incorporated in the layer containing organic particles according to the present invention, or layers other than the layer containing organic particles.

The cationic polymer may be a water soluble polymer or in the form of polymer particles.

Examples of the cationic water soluble polymers include a cationized polyvinyl alcohol, a cationized starch, a cationized polyacrylamide, a cationized polymethacrylamide, polyamidopolyurea, pblyethyleneimine, an epichlorohydrin/dialkylamine adduct polymer, a polymer of diallylalkylamine or its salt, a polymer of diallyldialkylammonium salt, copolymer of diallylamine or its salt and sulfur dioxide, a diallyldialkylammonium salt/sulfur dioxide copolymer, a polymer of quaternary salt of dialkylaminoethyl (meth)acrylate, a diallyldialkylammonium salt/acrylamide copolymer, an amine/carboxylic acid copolymer and the like.

The cationic polymer particles refer to cationic polymer particles not having water swellability or solubility, for example, organic particles of a polymer obtained by copolymerizing 70 to 100% by weight of one, or two or more members selected from among monomers such as ethylene, styrene and a (meth)acrylic acid ester not containing a carboxylic acid group or an amino group with 0 to 30% by weight of another copolymerizable monomer with the use of an initiator having an amidino group, and/or organic particles obtained by the use of a cationic dispersant such as a cationic surfactant.

[Construction of Recording Sheet]

In a preferred example of construction of the recording sheet of the present invention, the layer containing the organic particles is used as a layer engaged in ink receiving. The recording sheet of the present invention can be, for example, a monolayer structure consisting of a support and, superimposed thereon, only the layer containing organic particles, or a multilayer structure comprising a support and, superimposed thereon in sequence, an ink receiving layer and the layer containing organic particles according to the present invention, or a multilayer structure comprising a support and, superimposed thereon in sequence, the layer containing organic particles according to the present invention and another layer.

Although the amount of the layer containing organic particles according to the present invention is not particularly limited, it is generally satisfactory to superimpose 1 to 300 g/m², in terms of basis weight, of the same on a sheet support.

[Process for Producing Recording Sheet]

The recording sheet of the present invention can be produced by coating one major surface or both major surfaces of a sheet support with a coating composition containing organic particles and drying the coating composition so as to form a layer. The method of application of a coating composition in liquid form is not particularly limited, and use can be made of, for example, conventional application techniques by means of an air knife coater, a roll coater, a bar coater, a blade coater, a slide hopper coater, a gravure coater, a flexogravure coater, a curtain coater, an extrusion coater, a floating knife coater, a comma coater, a die coater or the like. The coating is followed by the drying.

When it is intended to impart gloss to the obtained recording sheet, the treatment method for imparting gloss is not particularly limited and known methods can be employed. For example, the calendering method wherein the recording sheet is passed between rolls having pressure and heat applied thereto so as to smooth the coating layer surface, or the cast coating method can be employed.

### EFFECT OF THE INVENTION

Organic particles are employed in the ink jet recording sheet of the present invention, so that a coating layer wherein the same interparticulate voids as those of inorganic particles are retained until printing can be formed. Further, after printing, the organic particles are swollen or dissolved by an ink so as to result in elimination of the interparticulate voids. Consequently, the penetration of gas would be inhibited, so that the recording sheet exhibiting excellent ozone resistance can be obtained. Still further, when the recording sheet furnished with a gloss surface is obtained by the use of organic particles according to the present invention, only the organic particles which are present in surface portions are partly deformed, so that the smoothness of the surface can also be enhanced.

Therefore, the present invention can provide an ink jet recording sheet which is excellent in both ink absorptivity and ozone resistance, and can also provide a process for producing the ink jet recording sheet.

### EXAMPLE

The present invention will be further described below with reference to the following Examples, which however in no way limit the scope of the present invention. In the following Examples, the parts and % refer to parts by weight and % by weight, respectively, unless otherwise specified.

### Example 1

<Preparation of Organic Particles>

195.9 parts of deionized water and 0.3 part of sodium dodecylbenzenesulfonate were charged into a reaction vessel, and heated to 70° C. in a nitrogen stream. 0.6 part of potassium persulfate was added to the mixture. Separately, 60 parts of methyl methacrylate, 20 parts of styrene, 20 parts of methacrylic acid and 0.5 part of t-dodecylmercaptan were emulsified into 40 parts of deionized water in the presence of 0.3 part of sodium dodecylbenzenesulfonate to thereby obtain an emulsified mixture. This emulsified mixture was dropped into the above reaction vessel over a period of 4 hr. Thereafter, the vessel contents were maintained at the same temperature for 4 hr to thereby complete the polymerization reaction.

As a result, an emulsion composition wherein organic particles were dispersed in water at a pH value of 3 was obtained. The diameter of powdery particles obtained by drying the emulsion composition, determined by observation through an electron microscope, was 85 nm. The glass transition temperature thereof determined from DSC curve in accordance with Japanese Industrial Standard (JIS) K 7121 was 110° C. The emulsion was a milk white opaque liquid at a pH value of 3, but when the pH value was changed to 8 by the addition of a 2% aqueous sodium hydroxide solution, the particles were dissolved in water to thereby obtain a transparent liquid.

<Preparation of Recording Sheet>

A wood free paper of 105 g/m² basis weight was coated with the above emulsion composition having organic particles dispersed in water at a pH value of 3 by means of a bar coater so that the coating amount was 30 g/m² in absolute dry condition, and dried at 60° C. for 300 sec, thereby obtaining a recording sheet.

### Example 2

<Preparation of Recording Sheet>

The recording sheet obtained in Example 1 was passed through a specular roll machine having its surface temperature maintained at 75° C. while effecting pressurized contact therebetween at a linear pressure of 70 kg/cm, thereby obtaining a glossy recording sheet. The 75° glossiness of the surface of the recording sheet, measured by means of deformation gloss meter GM-3D (manufactured by Murakami Shikisai Gijutsu Kenkyusho Sha) in accordance with Japanese Industrial Standard (JIS) Z 8741, was 82%.

### Example 3

<Preparation of Recording Sheet>

167 parts of the emulsion composition of pH 3 produced in Example 1, 363 parts of water, 50 parts of silica X-37 (produced by Tokuyama Corporation) and 20 parts of polyvinyl alcohol PVA 124 (produced by Kuraray Co., Ltd.) were mixed together, thereby obtaining a coating liquid. A wood free paper of 105 g/m² basis weight was coated with this coating liquid by means of a bar coater so that the coating amount was 20 g/m² in absolute dry condition, and dried at 60° C. for 300 sec, thereby obtaining a recording sheet.

### Example 4

<Preparation of Organic Particles>

700 parts of isopropyl alcohol, 65 parts of acrylamide, 5 parts of methylenebisacrylamide, 15 parts of methacrylic acid and 15 parts of methyl chloride quaternary salt of N,N-dimethylaminopropylacrylamide were charged into a reaction vessel, and heated to 70° C. in a nitrogen stream. 0.5 part of azobisisobutyronitrile was added to the mixture. The mixture was maintained at 70° C. for 8 hr, thereby obtaining a particle dispersion. Isopropyl alcohol was evaporated off from the particle dispersion by means of an evaporator, and dried. Thus, particle powder was obtained. The particle diameter of dried particle powder, determined by observation through an electron microscope, was 310 nm. When the powder was added to water and re-dispersed to thereby obtain a dispersion of 10% nonvolatile content and thereafter a 2% aqueous sodium hydroxide solution was added so as to adjust the pH value of the dispersion to 8, the particle diameter became 2500 nm. The glass transition temperature thereof determined from DSC curve in accordance with Japanese Industrial Standard (JIS) K 7121 was 150° C.

<Preparation of Recording Sheet>

50 parts of obtained particle powder was mixed with 117 parts of water. A recording sheet was prepared in the same manner as in Example 3 except that 1.67 parts of emulsion composition used in Example 3 was replaced by this mixture.

### Comparative Example 1

<Preparation of Recording Sheet>

100 parts of silica X-37 (produced by Tokuyama Corporation), 480 parts of water and 20 parts of polyvinyl alcohol PVA 124 (produced by Kuraray Co., Ltd.) were mixed together, thereby obtaining a coating liquid. A wood free paper of 105 g/m² basis weight was coated with this coating liquid by means of a bar coater so that the coating amount was 20 g/m² in absolute dry condition, and dried at 60° C. for 300 sec, thereby obtaining a recording sheet.

### Comparative Example 2

<Preparation of Organic Particles>

195.9 parts of deionized water and 0.01 part of sodium dodecylbenzenesulfonate were charged into a reaction vessel, and heated to 70° C. in a nitrogen stream. 0.6 part of potassium persulfate was added to the mixture. Separately, 98 parts of styrene and 2 parts of methacrylic acid were emulsified into 40 parts of deionized water in the presence of 0.1 part of sodium dodecylbenzenesulfonate to thereby obtain an emulsified mixture. This emulsified mixture was dropped into the reaction vessel over a period of 4 hr. Thereafter, the vessel contents were maintained at the same temperature for 4 hr to thereby complete the polymerization reaction. As a result, an emulsion composition wherein organic particles were dispersed in water was obtained. The diameter of powdery particles obtained by drying the emulsion composition, determined by observation through an electron microscope, was 210 nm. The glass transition temperature thereof determined from DSC curve in accordance with Japanese Industrial Standard (JIS) K 7121 was 118° C. The emulsion was a milk white opaque liquid at a pH value of 3, and even when the pH value was changed to 8 by the addition of a 2% aqueous sodium hydroxide solution, there was no appearance change and no change of particle diameter.

<Preparation of Recording Sheet>

A recording sheet was produced in the same manner as in Example 1 except that the above obtained emulsion composition was used.

[Method of Evaluation]

The results of measurement of the water swellability of organic particles prepared in Examples 1 and 4 are listed in Table 1. The quality evaluation results for the recording sheets prepared in Examples 1 to 4 and Comparative Examples 1 and 2 are listed in Tables 2 and 3.

Measuring and evaluation were performed in the following manner.

<Method of Measuring Water Swellability>

With respect to the powdery particles after drying and pulverization, the particle diameter thereof was measured by observation through an electron microscope. With respect to the liquid dispersions, the particle diameter thereof was measured by laser particle diameter analyzing system LPA-3000/3100 (Otsuka Electronics Co., Ltd.). In the evaluation results, ◯ means that the diameter of particles in water of pH 8 was 5.0 times that exhibited in the dry state or greater, or that the particles were dissolved in the water. x means that the diameter of particles in water of pH 8 was less than 5.0 times that exhibited in the dry state.

<Method of Measuring Ink Absorptivity>

Solid printing of each of yellow, magenta, cyan and black was effected in the longitudinal direction of recording sheet by means of commercially available ink jet printer (model PM2000C manufactured by Seiko Epson Corporation). Immediately after delivery from the printer, PPC paper was pressed onto the upper surface of the recording sheet, and the degree. of transfer of ink from the recording sheet to the PPC paper was evaluated by visual inspection. Evaluation criterion was as follows.

◯: No ink transfer was observed, thereby attesting to excellent ink absorptivity.

Δ: Slight ink transfer. was observed, but the ink absorptivity was on a practicable level.

×: Ink transfer was extensive, so that the ink-absorptivity was below a practicable level.

<Method of Measuring Light Fastness>

Solid printing of each of yellow, magenta, cyan and black was effected on each recording sheet by means of commercially available ink jet printer (model PM2000C manufactured by Seiko Epson Corporation). The recording sheet after printing was exposed to light for 100 hr by means of a xenon fadometer, and the residual ratio of optical reflection density after the exposure test was measured and referred to as “light fastness”. The optical reflection density was measured by means of Macbeth densitometer (RD-918).

<Method of Measuring Ozone Resistance>

Solid printing of each of yellow, magenta and cyan was effected on each recording sheet by means of commercially available ink jet printer (model PM2000C manufactured by Seiko Epson Corporation). The recording sheet after printing was placed in a glass container furnished with an ozone inlet and an ozone outlet. Ozone. (about 100 ppm) produced by ozonizer OS-100 manufactured by Silver Seiko Ltd. was continuously introduced into the glass container for 1 hr. Chromaticity difference (ΔE) caused by the ozone exposure test was determined by the method of Japanese Industrial Standard (JIS) Z8730. The smaller the AE value, the less the discoloration, meaning higher ozone resistance.

<Method of Measuring Color Strength>

Solid printing of black color was effected on each recording sheet by.means of commercially available ink jet printer (model PM2000C manufactured by Seiko Epson Corporation). The optical reflection density thereof was measured by means of Macbeth densitometer (RD-918).

TABLE 1

| | Diam. | | | | |
|---|---|---|---|---|---|
| | of | | | | Glass |
| | dried | | | | tran- |
| | parti- | Particle | | Water | sition |
| | cles, | diam. at | Swelling | swell- | temp. |
| | nm | pH 8, nm | ratio | ability | ° C. |
| Org. particles pre- | 85 | dissolved | Dissolved | ◯ | 110 |
| pared in Example 1 | | | | | |
| Org. particles pre- | 310 | 2500 | 8.1 | ◯ | 150 |
| pared in Example 4 | | | | | |
| Org. particles pre- | 210 | 215 | 1 | X | 118 |
| pared in Comp. Ex. | | | | | |
| 2 | | | | | |

TABLE 2

| | Ink absorp- | Color |
|---|---|---|
| | tivity | strength |
| Example 1 | ∘ | 1.65 |
| Example 2 | ∘ | 2.10 |
| Example 3 | ∘ | 1.45 |
| Example 4 | ∘ | 1.43 |
| Comp. Ex. 1 | ∘ | 1.21 |
| Comp. Ex. 2 | ∘ | 1.23 |

TABLE 3

| | Light fastness (%) | | | Ozone resistance (ΔE) | | |
|---|---|---|---|---|---|---|
| | yellow | magenta | cyan | yellow | magenta | cyan |
| Example 1 | 80.8 | 73.5 | 83.5 | 3 | 3 | 7 |
| Example 2 | 79.3 | 73.5 | 82.2 | 2 | 3 | 6 |
| Example 3 | 70.5 | 66.3 | 73.2 | 6 | 7 | 16 |
| Example 4 | 70.1 | 64.8 | 71.2 | 10 | 10 | 26 |
| Comp. Ex. 1 | 58.2 | 53.2 | 60.1 | 19 | 22 | 50 |
| Comp. Ex. 2 | 69.5 | 63.5 | 70.3 | 18 | 17 | 38 |

1. An ink jet recording sheet comprising a sheet support and, superimposed thereon, at least one layer containing organic particles,
the organic particles having a property of swelling in water so as to have a particle diameter which is 5.0 times that exhibited in the dry state or greater, or being soluble in water.

2. The ink jet recording sheet as claimed in claim 1, wherein the organic particles are organic particles having at least one hydrophilic group selected from among a carboxylic acid group and an amino group.

3. The ink jet recording sheet as claimed in claim 2, wherein the organic particles are organic particles obtained by copolymerizing:
(A) at least one monomer selected from among a carboxylic acid having a polymerizable double bond, an aminated (meth)acrylate monomer and an aminated (meth)acrylamide monomer,
(B) a monomer having one polymerizable double bond other than the monomer (A), and
(C) a monomer having two polymerizable double bonds other than the monomer (A).

4. The ink jet recording sheet as claimed in claim 3, wherein the monomer (A) is used in an amount of 10 to 50% by weight, the monomer (B) in an amount of 50 to 90% by weight, and the monomer (C) in an amount of 0 to 6% by weight, based on the total weight of monomers (A) to (C).

5. The ink jet recording sheet as claimed in claim 3, wherein at least one member selected from among methyl methacrylate, acrylamide and methacrylamide is contained as the monomer (B) having one polymerizable double bond other than the monomer (A) in an amount of 40 to 100% by weight based on the total weight of the monomer (B) having one polymerizable double bond other than the monomer (A).
